(19) United States
(12) Patent Application Publication
(10) Pub. No.: US 2014/0226537 A1
(43) Pub. Date: Aug. 14, 2014

(54) Conferencing Techniques

(71) Applicant: Bandwidth.com, Inc., Raleigh, NC (US)

(72) Inventors: Jared Kashimba, Micanopy, FL (US); Adam Cook, Apex, NC (US); Sai Rathnam, Raleigh, NC (US); Chris Chuang, Raleigh, NC (US)

(73) Assignee: Bandwidth.com, Inc., Raleigh, NC (US)

(21) Appl. No.: 14/254,975

(22) Filed: Apr. 17, 2014

(51) Int. Cl. H04L 29/06

(52) U.S. Cl. CPC H04L 65/1069; H04L 65/4053
USPC 370/261

(57) ABSTRACT

Disclosed are techniques for creating a conference connection. An IP network hosted application server receives an invite message that includes contact information for conference participants. The application server creates a customized invitation message using the contact information and sends it to a device associated with conference participants. The application server receives response messages accepting the invitation from participants' devices that include a means of contact for conference participants. The application server creates a conference data record including the means of contact associated with the conference participants and a date/time for the conference. The application server forwards the conference data record to a conference server operable to initiate a conference to the conference participants at the date/time specified using the means of contact included in the response messages. The connections are joined into a conference with other conference participants.

### BACKGROUND

Communication devices utilizing wireless communication protocols are ubiquitous. These devices utilize a cellular network (e.g., GSM or CDMA) to place and receive telephone calls to other communication devices. A communication device may include another mobile communication device on the same or another cellular network, a Voice-over Internet Protocol (VoIP) communication device, a hybrid VoIP/Cellular communication device and/or a plain old telephone service (POTS) communication device. Moreover, a variety of computer devices may utilize communication interfaces and protocols for exchanging audio, video, and text data over an Internet Protocol (IP) network such as, for instance, the Internet. Each of these telephony or computer communication devices may use a different access network but all are interfaced at some point to allow for communication among the different networks.

Setting up and conducting conferences among one or more of the aforementioned devices in a simple intuitive manner is a desired feature. Current telephonic systems may utilize a dial-in telephone number and access code that each participant must go through to gain access to a conference bridge. Thus, the participants are required to place an outgoing call to a bridge line and then enter an authentication code before being connected with the other participants. This can be tedious and even dangerous if a participant is using a mobile communication device while operating a motor vehicle. What is needed is a simpler way to establish and connect to a conference.

Described herein are methods, systems, and techniques for constructing and executing a conference.

### BRIEF DESCRIPTION OF THE DRAWINGS

FIG. 1 illustrates an exemplary networked environment for implementing certain exemplary embodiments described herein.

FIG. 2 is a block diagram illustrating some of the functions of a conference server according to one or more embodiments described herein.

FIG. 3 is a block diagram illustrating some of the functions of an application server according to one or more embodiments described herein.

FIG. 4 is a block diagram illustrating a communication device according to one or more embodiments described herein.

FIG. 5 is a first messaging diagram according to one or more embodiments described herein.

FIG. 6 is an illustration of a logic flow diagram for constructing a conference according to one or more embodiments described herein.

### DETAILED DESCRIPTION

The embodiments described herein disclose systems and methods for intelligently structuring, handling, and executing conferences among computer and communication devices. The systems and methods of the invention may be embodied in and performed by communication devices, conference servers, conference servers and other devices, and software instructions executed by some or all of such devices, as will be explained in detail below. One or more of the aforementioned devices may be combined. For example, a conference server may include the functions of a conference server or vice-versa. The different types of networks contemplated herein include, for example, cellular mobile networks, cellular mobile networks utilizing Internet Protocol (IP) protocol(s), the public switched telephone network (PSTN), and data networks, such as the Internet or other packet switched IP-based networks, including wide area networks, local area networks, and combinations thereof.

As used herein the term “conference” is meant to generally indicate a two-way exchange of audio (e.g., voice telephony call or audio streaming data), video (e.g., video telephony call or video streaming data), text (e.g., instant messaging (IM) chat sessions), and other information or any combination thereof between two or more computer and/or communication devices. As used herein, the term “device” is intended to mean a device capable of connecting to one or more telephony network(s) (e.g. the PSTN, one or more cellular mobile networks, one or more VoIP networks), one or more data networks (e.g., the Internet, local area networks (LANs)). A device may be wired or wireless and may operate on one or more telephony networks including, but not limited to, a packet switched IP-based network, a cellular mobile network, or the PSTN. As used herein, the term “communication link” is intended to mean a physical or logical channel that connects two or more devices. A communication link may be a signaling link or a media link. In this context, a conference may be established via one or more communication links. One or more media streams may be transmitted over a communication link. A conference server may be situated between devices thereby making the conference server an endpoint in a communication link. A conference server may be hosted within an IP network such as, for instance, the Internet or a LAN/WAN accessible to the Internet.

The convergence of and inter-operation among different types of network technologies (e.g., heterogeneous network inter-operability) blurs the line between various distinct networks. This disclosure's discussion of networks includes the portion of a network that connects devices to a service provider's core network. This portion of a network may also be referred to as the interface between the device and the network. Another type of interface may be the interface between networks. That is, the interface necessary to facilitate seamless communication from one network to another.

Therefore, references herein to a device capable of connecting to or communicating via a cellular mobile network refer to a device equipped with a cellular transceiver for wireless communication with basestations and other cellular mobile access points. Similarly, references herein to a device capable of connecting to or communicating via a data network refer to a device equipped with a transceiver or other network interface for wireless communication (e.g., 802.11) with a router or other data network access point. One particular device may be characterized herein as a wireless handset. A wireless handset may include multiple RF transceivers, one of which may be operable to connect to an access network for a cellular mobile network and another of which may be operable to connect to an access network for an IP data network (e.g., 802.11).

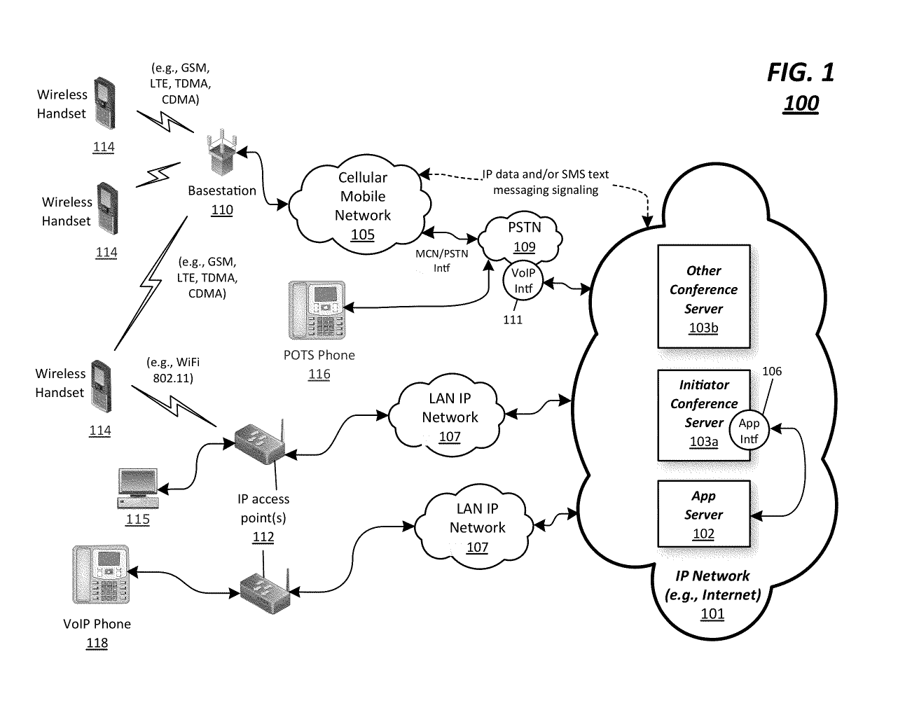

FIG. 1 illustrates an exemplary networked environment 100 for implementing certain exemplary embodiments described herein. The networked environment 100 may include multiple distinct inter-connected networks such as, for instance, a large scale Internet Protocol (IP) network (e.g., the Internet) 101, one or more IP based local area networks (LAN) 107, cellular mobile networks 105, and the PSTN 109. While these distinct networks utilize different protocols and signaling schemes, there are various interfaces (not shown) that allow for the seamless transition of voice and data (including text, audio, and video) such that various devices may communicate with one another over one or more of these inter-connected networks.

The PSTN 109 can be characterized as a circuit switched point-to-point communication network in which a physical connection between the endpoints is maintained for the duration of the connection or communication link. The PSTN 109 may also be referred to as the legacy telephone network as it is the backbone infrastructure for connecting communication devices comprised of Plain Old Telephone Service (POTS) phones 116.

Cellular mobile networks 105 may come in different varieties based on the radio transmission scheme between a device known as a wireless handset (e.g., mobile or cellular phone) 114 and the cellular mobile network basestation 110 that is in communication with the wireless handset 114. Two such radio transmission schemes are the Global System for Mobile Communication (GSM) and Code Division Multiple Access (CDMA). These radio transmission schemes are incompatible with one another necessitating an intervening interface to allow communication between endpoints on either network. In addition, each network may operate over a specific frequency ranges. Often, there may even be an intervening network such as the PSTN 109 between two distinct cellular mobile networks 105. Each cellular mobile network 105 includes an interface to the PSTN 109 such that calls crossing that interface can be handled by the receiving network whether it is a cellular mobile network 105 or the PSTN 109.

Various cellular mobile network operators base their network on one of the radio transmission schemes and provide service to wireless handsets 114 using that radio transmission scheme over a defined frequency band. For example, a wireless handset 114 wirelessly communicates with a basestation 110 that serves as an access network to the cellular mobile network 105. The basestation 110 authenticates and authorizes the wireless handset 114 to the cellular mobile network 105 and, in conjunction with other equipment within the cellular mobile network 105, manages calls to and from the wireless handset 114. The cellular mobile network 105 provides connectivity for any wireless handsets 114 capable of cellular transmission that are physically located within range of the cellular mobile network 105. The range of a cellular mobile network 105 depends in part on an amplification, power, and/or energy associated with the antennas comprising cellular base station, wireless handsets 114 and the like.

Similarly, an IP based data network 107 like the Internet 101 may provide wireless connectivity to wireless handsets 114 that are also VoIP enabled and VoIP communication devices 118 within range of an IP access point 112. For instance, an IP access point 112 may provide wireless connectivity using any of the 802.11 WiFi standards and/or any other type of IP based connectivity standard. As will be appreciated by those of skill in the art, a wireless handset 114 or VoIP communication device 118 may experience a stronger connection signal when located closer to an IP access point 112 than when located further away from the IP access point 112. Thus, the strength of the wireless data connection may fade as the dual mode wireless handset 114 or VoIP communication device 118 moves away from an IP access point 112. In some cases the VoIP communication device 118 may be wired directly to the IP access point 112 via, for instance, an Ethernet coupling. In another embodiment, a computer device 115 may be used to create and exchange messages with an application server 102 (described below). In addition, if the computer device 115 includes telephony hardware/software, it may also exchange signaling and media data with a conference server like initiating conference server 103a (described below). The computer device 115 may also send and receive media streams via means other than a telephony protocol.

The collection of IP based data networks illustrated in FIG. 1 such as LANs 107, and the Internet 101 all run on a packet based data transfer protocol characterized as packet switching. Packet switching essentially chops up a data stream (e.g., text, voice, data) into segments and transfers them across an IP network to a destination where the packets are re-assembled into the original data stream for output. Voice over IP (VoIP) is a specialized subset of IP packet based communication directed to IP telephony. VoIP communication devices 118 utilize an IP access point 112 to the larger IP network such as LAN 107 and then Internet 101. The IP access point 112 may be wired, wireless (e.g., WiFi), or a combination wired/wireless access point such as those illustrated in FIG. 1. A VoIP communication device 118 may communicate with an IP access point 112 to gain access to the larger IP network 101 and other communication devices. The VoIP communication device 118 has been illustrated as a wireline type device but may just as easily be a wireless device communicable with the IP access point 112 over, for instance, one or more of the 802.11 protocols.

In certain embodiments, cellular mobile network(s) 105 include cellular networks or portions of cellular networks based on GSM, LTE, CDMA, and/or any other cellular network standards. IP based data networks 107, 101 include, for example, the Internet, one or more intranets, wide area networks (WANs), local area networks (LANs), and the like, portions or all of which may be wireless and/or wired. For instance, an IP based data network 107, 101 may be a wireless network or a portion of a wireless network implemented using an IEEE 802.11 standard, WiMAX, and/or any other wireless data communication standard.

The various networks 109 (PSTN), 105 (Cellular), 107, 101 (IP Based) may interface with a conference server 103a or 103b through gateway devices, routers and/or other appropriate devices (not shown). Similarly, the wireless handsets 114 may interface with the various networks 109 (PSTN), 105 (Cellular), and 107, 101 (IP based) through appropriate access points 110, 111, 112 (others not shown).

An application server 102 may also reside within the packet based IP network 101 and may be configured to communicate with multiple communications devices to exchange signaling and information pertaining to setting up a conference. The application server 102 may be communicable with the initiating conference server 103a that also resides within the packet based IP network 101. In some embodiments, the application server may be co-located with the initiating conference server 103a or the functions of the application server may be performed by the initiating conference server 103a. The application server 102 may provide information such as telephone numbers or other means of contact (e.g., email, SMS/text message, IM, web browser) to the initiating conference server 103a so that the initiating conference server 103a may establish and maintain a conference as described above. Sometimes a telephone number or other means of contact may be associated with a communication device that is not directly reachable by initiating conference server 103a. In such instances, conference server 103a may communicate with an “other conference server 103b” that can reach the communication device of that telephone number. The application server 102 and the initiating conference server 103a may be bundled together or may be separate but communicable with one another.

In addition, the wireless handsets 114 via the cellular mobile network 105 are capable of sending data including short message service (SMS) text messages through the cellular mobile network 105 into the IP network(s) 101, 107. Similarly, the application server 102 and initiating conference server 103a may also be capable of sending data including SMS text messages through the IP network(s) 101, 107 and into the cellular mobile network 105 to reach wireless handsets 114.

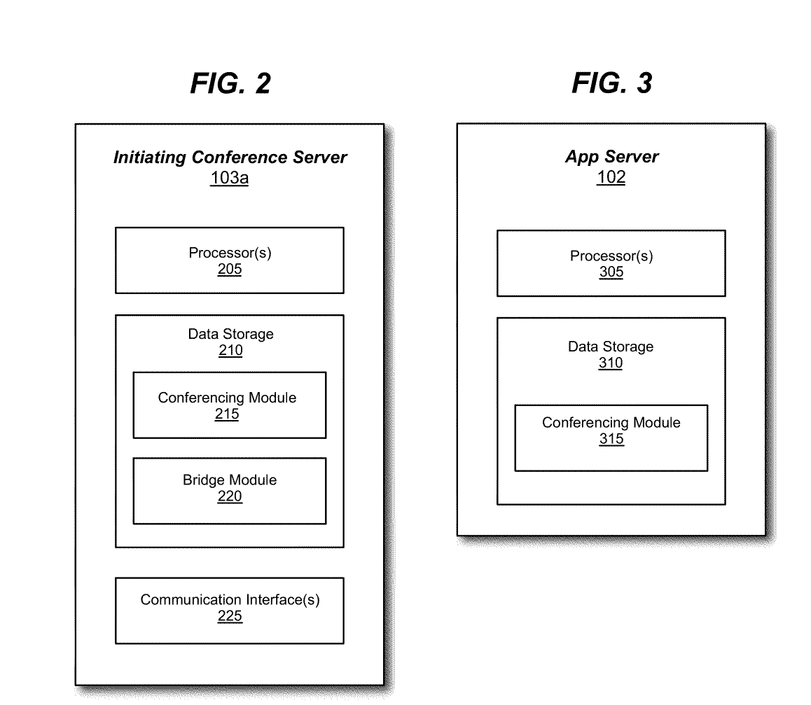

FIG. 2 is a block diagram illustrating some of the functions of the initiating conference server 103a according to one or more embodiments described herein. The initiating conference server 103a may comprise, for example, a server computer or any other system having computing capability. The initiating conference server 103a may be hosted in a packet based IP network such as, for instance, the Internet. The schematic block diagram shows that the initiating conference server 103a may include at least one processor 205, a data storage component 210 storing a conferencing module 215 and a bridge module 220, and one or more communication interfaces 225. The data storage component 210 may further store or link to information on current and/or previous conferences including means of contact information for participants, conference recordings, transcriptions, conference chat communication, conference shared data such as, but not limited to screen share video, documents, pictures, audio/video media content, collaborative markups, participant notes, etc.

The conferencing module 215 may be responsible for connecting the various legs of a conference together. Each participating device in a conference is communicable with the initiating conference server 103a over a separate call leg. The bridge module 220 joins the appropriate call legs together to create group communication.

The bridge module 220 may be responsible for processing call flows including setting up and tearing down call legs with various devices and other conference servers. In one embodiment, the conferencing module 215 may send and receive session initiation protocol (SIP) messages. While the conferencing module 215 may utilize a VoIP protocol such as SIP, it can communicate with end user devices that are not VoIP or SIP based by routing through other conference servers that perform interface conversions from SIP to other protocols such as, for instance, SS7 for the PSTN or CDMA/TDMA/GSM for cellular mobile networks.

Alternatively, a plurality of initiating conference servers 103a may be employed and may be arranged, for example, in one or more server banks or computer banks or other arrangements. For example, a plurality of initiating conference servers 103a together may comprise a cloud computing resource, a grid computing resource, and/or any other aggregated or distributed computing arrangement. Such initiating conference servers 103a may be located in a single installation or may be distributed among different geographical locations. For purposes of convenience, the initiating conference server 103a is illustrated in FIGS. 1 and 2 and referred to herein in the singular. Even though the initiating conference server 103a is referred to in the singular, it is understood that a plurality of initiating conference servers 103a may be employed in various arrangements as described above. In addition, the conference server functions may themselves be separated into different servers. For example, there may be one or more conference servers 103a hosting and executing conferencing modules 215 and one or more conference servers 103a hosting and executing bridge modules 220. Such an architecture may be representative of a media server handling the conference media stream while other conference servers handle call flow signaling and coordinate the use of a media server for media.

The communication interface(s) 225 may include a voice-over-IP (VoIP) interface adapted to exchange IP based telephony signaling and/or media data with other IP network devices using a VoIP protocol. Another communication interface 225 may be a PSTN interface adapted to convert incoming PSTN audio data to VoIP audio data and convert outgoing VoIP audio data to PSTN audio data. Still another communication interface 225 may be an IP data interface 117 adapted to exchange IP data with other IP network devices. The IP data may be indicative of streaming audio and/or streaming video. This may also include IP data exchanged with a mobile wireless handset over an intermediate cellular mobile network. Another communication interface may be the app interface 106. The app interface 106 is specifically directed to exchanging data between the initiating conference server 103a and the application server 102. Yet another communication network interface 225 may be directed toward an alternative network (not shown) adapted to exchange data with a computing and/or communications device. Examples of alternative network(s) may include, but are not limited to, WiMax and whitespace. A whitespace network may be characterized as one that utilizes frequency spectrum that is overlapping with that of broadcast television frequency spectrum.

FIG. 3 is a block diagram illustrating some of the functions of the application server 102 according to one or more embodiments described herein. The application server 102 may comprise, for example, a server computer or any other system having computing capability. The application server 102 may be hosted in a packet based IP network such as, for instance, the Internet. The schematic block diagram shows that the application server 102 may include at least one processor 305 and a data storage component 310 storing a conferencing module 315. The data storage component 310 may further store or link to information on current and previous conferences including contact information for participants, conference recordings, transcriptions, conference chat messaging communication, conference shared data such as screen share video, documents, pictures, audio/video media content, collaborative markups, participant notes, etc. In addition, the application server 102 may be communicative with devices that include calendar programs (e.g., Google™ Calendar, Microsoft™ Outlook™). The application server may be able to receive calendar event data from such calendar programs. For instance, the application server may scan calendar events for conference events that may be characterized as invitations to conference. Alternatively, the calendar programs may be configured to automatically send conference events to the application server 102 upon entry into the calendar program.

The application server 102 may also be communicable with a conferencing application on a mobile device 114. As will be described in more detail below, the conferencing application of a wireless handset may send data to the application server 102 indicative of a desire to set up a conference with one or more other participants via their device(s). The application server 102 may receive a conference setup request comprising a list of participants, at least one telephone number or other means of contact for each participant, and a proposed date/time for the conference from an initiator of the conference. In another embodiment, the application server 102 may store means of contact data for frequently or previously used devices such that the conference setup request need only identify the name of the participant. The application server 102 may then lookup the name and determine the preferred means of contact for that participant. The initiator is also a participant and his/her name and means of contact such as, for instance, telephone number are also part of the conference setup request. The application server 102 parses the received data and creates an invitation message to all participants notifying them of the date and time of the proposed conference as well as a list of all participants. The invitation message may be distributed to each participant using one or more means of communication including, but not limited to, email, text message, push notification, or the like.

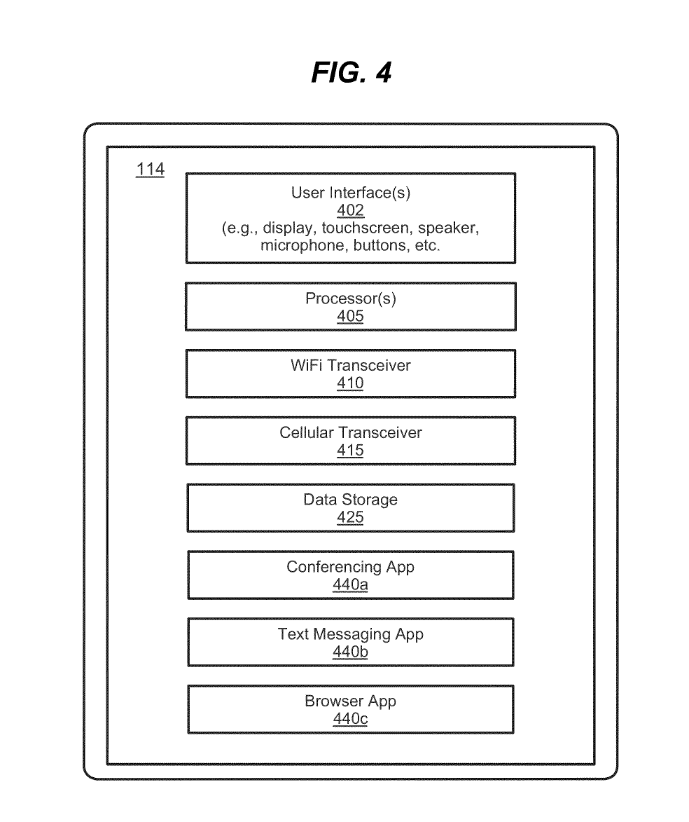

FIG. 4 is a block diagram illustrating a wireless handset 114 according to one or more embodiments described herein. The wireless handset 114 may include a processor or processors 405 for controlling the various components and functions of the wireless handset 114. The wireless handset 114 may also include multiple RF transceivers such as, for instance, a WiFi transceiver 410 and a cellular transceiver 415.

The WiFi transceiver 410 may be operable to communicate with an IP network access point 112 using one or more of the 802.11 wireless transmission protocols. Upon connection with an IP network access point 112, the wireless handset 114 may exchange IP data with servers or other computers that are connected with or communicable with the Internet 101 via LAN/WAN 107. This may include the application server 102 and initiating conference server 103a shown in FIG. 1.

The cellular transceiver 415 may be operable to communicate with a cellular mobile network 105 for both voice and IP data communication. On the voice side, the cellular mobile network 105 may be based on GSM, CDMA, TDMA or other communication protocols while on the IP data side, the cellular mobile network 105 may be based on, for example, GPRS, EDGE, EV-DO, HSPA-D, HSPA-U, LTE, UMTS-WCDMA, UMTS-TDD, etc.

The wireless handset 114 may further include data storage 425, software applications such as, for instance, a conferencing application 440a, a text messaging application 440b, and a browser application 440c. The wireless handset 114 may also include various user interface(s) 402. The data storage 425 may include, for example, one or more types of memory devices including, but not limited to, flash memory usable for ROM, RAM, PROM, EEPROM, and cache. Other software applications (not shown) may include, for example, one or more software applications executable on or by the processor(s) 405 including, but not limited to, email applications, contact applications, calendar applications, and specific data and/or audio/video applications. The user interface(s) 402 may include, for example, a display, a touchscreen for soft-key input, speaker(s), microphone(s), a keyboard for hard-key input, and one or more buttons. The data storage 425 may store contact data comprising for people including, but not limited to, multiple telephone numbers, email addresses, SMS enabled telephone numbers, postal addresses, and the like. The contact data may be used by a contact application in conjunction with other applications on the wireless handset 114 to facilitate communications with the people in the contact database.

The conferencing application 440a may facilitate setting up a future or spontaneous conference with one or more participants. Via the user interface(s) 402 and the conferencing application 440a, a user may initiate a conference. Via the conferencing application 440a an initiating user may identify one or more participants for a conference and date/time for the call. If the participants are in the user's contact database, specific information may be obtained from the contact database and included in a conference invite message to be sent to the application server 102. In another example, contact information may be obtained via the application server 102. The application server may be communicable with another cloud based server that contains contact information. This cloud based server contact information may be synced with contact data on a wireless handset 114. Having cloud based contact information available to the application server 102 permits usage of a web interface such as web browser 440c of wireless handset 114 or a web browser of another computing device that are VoIP enabled.

If a participant is not in the user's contact database, the conferencing application 440a may prompt the user for one or more contact telephone numbers, messaging addresses, and/or email addresses, etc. to which an invitation to the conference may be sent. In another example, the conferencing application 440a may obtain event information from a calendar application, the event information indicative of a conference. Moreover, the conferencing application 440a may prompt for a date/time for the conference. The user may input a specific date/time or may opt to start call now. This latter option may be referred to as a spontaneous conference as its intent is to create a conference as quickly as is practical upon notifying all requested participants.

In another embodiment the conferencing application 440a may allow the conference to be scheduled adhoc. In this embodiment when one or more required participants indicate overlapping availability the call will begin. For example, a group chat session or group SMS text message thread may be established among two or more participants. A decision may be made to convert the chat or SMS text message thread into an adhoc conference. If at least two participants indicate availability for the adhoc conference via a conference invite within the chat session or group SMS text message thread, a command to a conference server 103a may be sent including the relevant contact information of the participants with instructions for the conference server to set up a conference immediately.

Once on a conference, either adhoc or pre-scheduled, certain participant devices (e.g., wireless handset 114 or VoIP telephony enabled computing device) may be able to utilize speech recognition software and processing to receive and process a set of commands. For example, a participant may wish to include yet another person on the call and speak a command such as, “Conference John Black”. The command may be locally processed on the participant's device to find the contact information for John Black and forward it to the conference server with a telephony instruction to call John Black and bridge him to the existing conference. Other commands that may be speech recognized include, but are not limited to, a start recording, stop recording, pause recording, resume recording, etc.

In another embodiment, a participant may be able to switch devices while currently in a conference. For example, a participant may begin a conference on a wireless handset such as their mobile phone. The participant may be in transit and reach a destination such as their office and wish to switch from the wireless handset to a desk phone. The participant may create and send a message to the application server 102 indicative of the desire to switch to another device. The message may include a means of contact for the new device. The application server 102a may then send a message to the initiating conference server 103a with instructions to create another communication link and media stream from the conference server to the new device using the means of contact included in the message received by the application server 102. The initiating conference server 103a may then construct the new media stream once any signaling and response from the new device is achieved. As a last step, the media stream with the previous device may be terminated.

In another embodiment, the application server 102 may maintain a web-page presence for active conferences. For example, the application server may dynamically create and update a webpage URL that displays conference status and may even provide screen sharing for data (e.g., documents, slide presentations, etc.). With respect to conference status, a portion of the web page may graphically illustrate the names of the participants. When available, a photograph of the participant may also be associated with the name likely in a thumbnail format. This would allow participants to be on the conference with one device and use a second computer device to “view” the status of the conference. Such an implementation may also visually highlight in some manner the participant currently speaking. Adding the functionality just described provides for a richer conference experience. Participants are still free to use the device of their choice for connecting to the conference but may simultaneously have a web browser window open to the conference status web page that provides additional information and context for the conference.

The wireless handset 114 may also include a text messaging application 440b for sending and receiving short message service (SMS) text messages. SMS text messages are one mode of communication that may be used to communicate conference invitations and responses among participant devices and the application server 102. The wireless handset 114 may also include a browser application 440c for exchanging data for communicating conference invitations and responses among participant devices and the application server 102. In another embodiment, the wireless handset 114 may also include an email application (not shown) for sending and email messages. Email messages may be another mode of communication that may be used to communicate conference invitations and responses among participant devices and the application server 102. The wireless handset 114 may also include a calendar application (not shown) for managing calendar entries. Calendar entries when synced to an external calendar service may be used as another mode of communication to communicate conference invitations and responses among participants and the application server 102. The embodiments are not necessarily limited to the examples described herein.

FIG. 4 has been described as a wireless handset 114. Other types of telephony and/or computing devices may be used in addition to the just described wireless handset 114. For example, a networked computer having Internet connectivity may also include many of the same applications (e.g., text messaging, browser, email) that perform many of the same functions as wireless handset 114. If the networked computer further includes a cellular transceiver, it can perform all of the functions that are associated with the wireless handset 114. Similarly a VoIP terminal with a processor and programmable storage that is connected to an IP network may also include many of the same applications (e.g., text messaging, browser, email) that perform many of the same functions as wireless handset 114. Another example may be a tablet computer device with VoIP capabilities provided by the conferencing application 440a, natively, or though another application (not shown) which is connected to an IP network that may also include many of the same applications (e.g., text messaging, browser, email) that perform many of the same functions as wireless handset 114. Thus, a wireless handset 114 is only one type of device that can initiate a conference using the techniques described herein. Moreover, use of a telephone number as a means of contact is illustrated and described but the application server 102 may also be able to include devices that do not have telephone numbers directly associated with them but do have VoIP calling capability as, for example, a SIP endpoint. Thus, the contact information of a participant may be a SIP endpoint address that does not necessarily need to be in the form of a telephone number.

Included herein is a set of flow charts and message diagrams representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

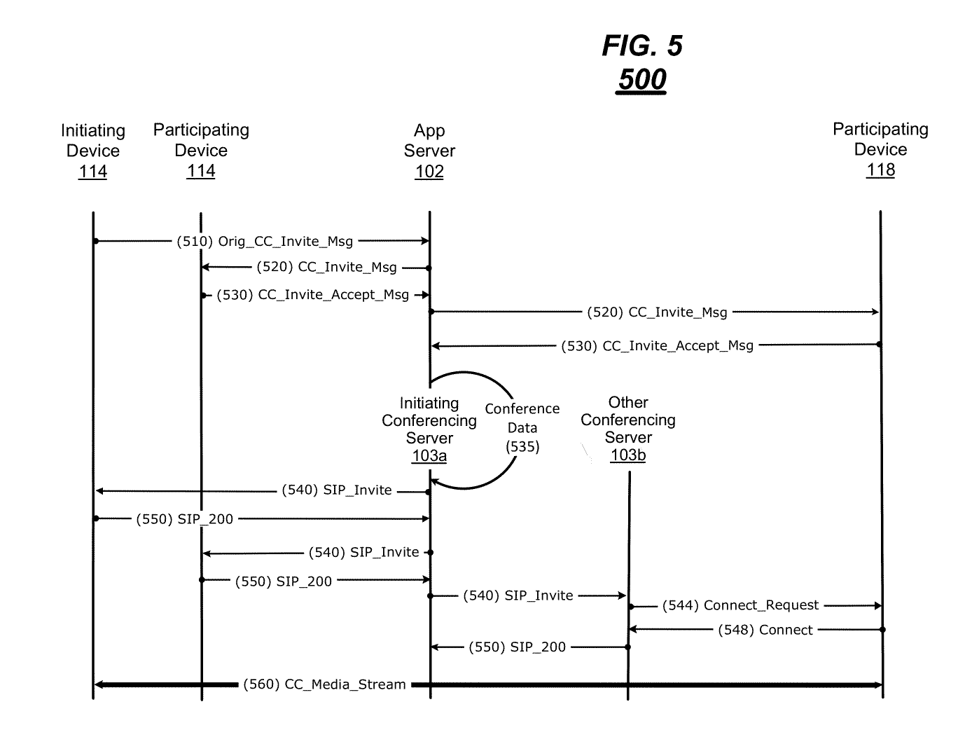

FIG. 5 is one embodiment of a messaging diagram for setting up and conducting a conference. In this embodiment, an initiating wireless handset device 114 creates and sends an original conference invite message (Orig_CC_Invite_Msg) 510 to an application server 102. The original invite message 510 may be generated on the wireless handset 114 using a specific application (e.g., conferencing app 440a), an email message, an SMS text message, a web-based browser communication, a calendar entry identifying participants, etc. The Orig_CC_Invite_Msg 510 may be parsed by the application server 102 to determine how many participants have been identified as well as points of contact for those participants. The points of contact may include, but are not limited to, text messaging, email, push notification via an end user device app (e.g., conferencing app 440a) calendar invite/entry, or a phone call. Upon receiving the Orig_CC_Invite_Msg 510 from the initiating device, the application server 102 may set up a data record indicative of the date/time the conference is to take place along with the designated telephone numbers of the participants including the telephone number of the initiating participant. The application server 102 may then create multiple conference invite messages (CC_Invite_Msg) 520 to be sent to each of the requested participants using one or more of the contact points for that participant. The CC_Invite_Msg 520 contains information about the proposed conference including, but not limited to, a list of participants, the initiating participant, a date/time, a subject or topic, and instructions for or a mechanism for responding to the invite. The response to the invite may also include a mechanism that allows the participant to specify a particular means of contact the user will use for the call that may include an alternate telephone number to be used. For example, the invite message 520 may include a default number for the participant likely the telephone number associated with the device that received the invite message 520. The participant, however, may be given the option of specifying a different device or telephone number (e.g., desk phone or home phone) for the proposed conference in an invite response message (CC_Invite_Accept_Msg) 530 In some embodiments a similar message construct may allow the person to rejoin a conference or switch (push to/pull from) or add devices or telephone numbers during a conference.

Each participant may respond to the invite message 520 with a response message (CC_Invite_Accept_Msg) 530 indicating whether they will or will not participate in the conference. Upon receiving a response message 530 from a participant device, the application server 102 may create or update a data record indicative of the date/time the conference is to take place along with the designated telephone number(s) (or other contact means) of the participants. The invite response message 530 may be formatted the same way as the invite message 520. For example, if the invite message 520 was received as a text message, the response message 530 may be a reply to the text message. Similarly, if the invite message 520 was received as an email message, the response message 530 may be a reply to the email message. If the invite message 520 was a push notification, the response message 530 may be an action taken on the push notification. For example, the push notification may include soft buttons for “accept”, “tentative”, “accept with different number”, or “deny”. Selecting “accept” may spawn a response message 530 back to the application server 102 indicating that the participant has accepted the conference and may be reached at the telephone number for the device that received the invite message 520 for the conference. Selecting “tentative” may spawn a response message 530 back to the application server 102 indicating that the participant is not sure yet whether they will participate in the conference. The application server may then periodically resend the invite message 520. In another embodiment, the invite message may be entered into the calendar application of the device receiving the invite message 520. A calendar reminder for the invite message 520 may periodically pop up on the device allowing the participant to choose one of the other options of “accept” “accept with new number”, or “deny”. Selecting “accept with new number” may spawn a response message 530 back to the application server 102 indicating that the participant has accepted the conference but is providing a different telephone number than that for the device that received the invite message 520. The different telephone number is the telephone number to be used for the conference. Selecting “deny” may spawn a response message 530 back to the application server 102 indicating that the participant has denied the conference. In each case of acceptance, the participant's device may also enter the conference into the calendar application of the device receiving the invite message 520. This may also occur if a server is integrated with a device's calendar function as well. The cloud based calendar server can scan regularly for external entries made, can add entries arising out of conference scheduling via conference app 440a or as a means of notifying the device of a new calendar entry. For example, an initiating participant sets up a conference with the application server 102. Another participant may also be a user of the service and may have previously linked their calendar application with the application server 102. If a participant has opted to be notified via calendar, they will receive a calendar invite from the application server 102 which may be accepted, tentatively accepted, or denied through normal calendar application functionality from a cloud based web page, a locally hosted computer application, or a calendar application hosted on a wireless handset 114, etc.

At the appropriate time, the application server 102 may forward the call data 535 to an initiating conference server 103a. The initiating conference server 103a via a conferencing module 215 and bridge module 220 may read the call data 535 and prepare resources to bridge and conference the participants. At the time specified for the conference, the initiating conference server 103a via the bridge module 220 may compose and send a series of SIP_Invite messages 540 with media specified via the conferencing module 215 directed to each of the VoIP devices or telephone numbers in the call data 535. A VoIP device is a SIP endpoint and does not necessarily need to include a telephone number. This includes the telephone numbers or contact means for the initiating device and all other participating devices. Since the initiating conference server 103a, in this example, is a SIP based conference server, the messaging to and from the initiating conference server 103a is also SIP based. Other IP based telephony protocols may be implemented in lieu of SIP. In addition, if the initiating conference server 103a were resident in a mobile cellular network, the call signaling may be altered to reflect the protocols used within the network in which the initiating conference server 103a resides. It should also be noted that while the initiating conference server 103a is SIP based, it may still connect with devices hosted in different telephony networks by way of interface servers that resolve messaging and signaling between different telephony networks. As earlier described, examples of different telephony networks include IP based VoIP, cellular, and circuit switched PSTN networks.

If the SIP_Invite message 540 encounters an intermediate interface server (e.g., other conference server 103b) before reaching the device associated with the telephone number to which the SIP_Invite message is intended, the other conference server 103b will translate the SIP_Invite message 540 to a Connect_Request message 544 and forward to the intended participating device. The Connect_Request label is generic and is not intended to represent any specific protocol or telecommunication signaling system. Rather, it is representative of whatever signaling or messaging is implemented by the other conference server 103b in communicating with participant devices. Thus, the Connect_Request message 545 may be an SS7 protocol message, a CDMA protocol message, a TDMA protocol message, etc. depending on the telecommunication protocol implemented by the other conference server 103b.

Each participating device may receive either a SIP_Invite message 540 or a Connect_Request message 544 and respond accordingly. In the case of SIP signaling, a SIP_{—}200 message 550 accepting the SIP_Invite message 540 may be returned to the initiating conference server 103a. In the case of alternate signaling, a form of a Connect message 548 may be returned to the other conference server 103b which, in turn, translates the Connect message 548 to a SIP_{—}200 message 550 and forwards the SIP_{—}200 message 550 to the initiating conference server 103a. The initiating conference server 103a via the conferencing module 215 may then join the various call legs between the initiating conference server 103a and the participant devices into appropriate media streams denoted as the CC_Media_Stream 560. The CC_Media_Stream 560 may traverse one or more telephony networks and one or more conference servers depending on the telephony network to which a participant device subscribes. Upon creating the media stream, a conference has been established by the initiating conference server 103a without any of the participating devices having to call take any action beyond answering a call.

It should be noted that the conference may have been set up as a spontaneous conference. A spontaneous conference is one in which the initiating participant does not specify a future date/time for the conference but rather indicates “now” when sending out the Orig_CC_Invite_Msg 510 to the application server 102. This is similar to the adhoc scheduling of a conference described above.

As described above, the initiating device need not be a wireless handset 114 but could be a telephony enabled computer device or a computer enabled VoIP device. Any device that has IP connectivity and VoIP capability along with the conferencing app can become an initiating or participating device. This may include, for example, a tablet or computer with WiFi connectivity, a tablet or computer with LTE connectivity, a WiFi only personal digital assistant (PDA) or handheld media type device, etc. A wireless handset 114 is used for purposes of illustration with respect to FIG. 5.

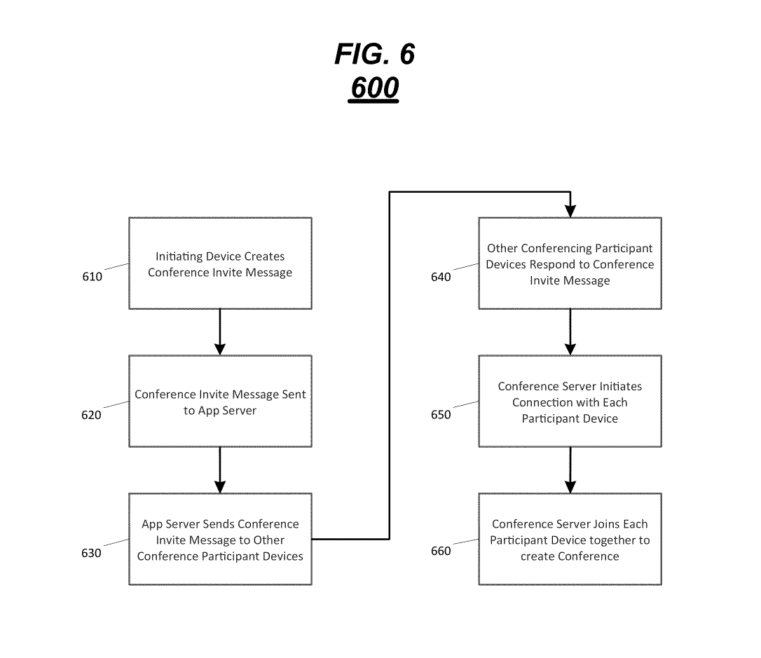

FIG. 6 illustrates one embodiment of a logic flow 600 for establishing a conference with one or more participants. The logic flow 600 may be representative of some or all of the operations executed by one or more embodiments described herein. In this embodiment, steps are disclosed that allow a telephony device to set-up a conference among a plurality of participants that may be scattered among a plurality of telephony networks wherein the conference is not dependent on a centralized calling number and/or code.

In the illustrated embodiment shown in FIG. 6, the logic flow 600 may cause an initiating telephony or computer device to create a conference invite message at block 610. For example, a user of a telephony device may wish to set up a conference immediately, adhoc based on collective participant availability, or for a future date among a plurality of participants. Rather than reserve time on a dedicated conference line and send out invites to each participant with the dial in number and code for the conference, the user, via a specialized application, text/SMS message, email, calendar entry, call, speech recognition, or a browser based window identifies a set of conference participants and at least one means of contact (e.g., telephone number) for each participant. This information may be obtained from a contacts application on the initiating telephony or computer device. The information may also come from the application server 102 where it has been configured by a user to access one or more contact services on the user's behalf, such as, for instance, Google™ contacts or Microsoft™ Outlook™. Alternatively, the information may be manually input. Manual input may include, for instance, text input from a keypad or touch screen as well as voice input. In the case of a computer device, a browser may be open to a web-page associated with a server having the functionality of application server 102. The interaction between computer device 115 and the web-page may create the conference invite message.

In the illustrated embodiment shown in FIG. 6, the logic flow 600 may cause the initiating telephony or computer device to send the conference invite message to an application server at block 620. For example, the initiating telephony or computer device may forward the conference invite message to the application server 102 using one of a variety of communication methods including, but not limited to, an in-app UI interaction, text/SMS message, email, calendar entry, call, speech recognition, or a browser based window. Regardless of the delivery mechanism, the data for the conference (e.g., participants telephone numbers, other means of contact, and date/time) may be packaged according to one of the aforementioned communication methods and sent to the application server 102.

In the illustrated embodiment shown in FIG. 6, the logic flow 600 may cause the application server to receive the conference invite message and send out separate conference invite messages to each of the identified participant devices at block 630. For example, the application server 102 may parse the incoming conference invite message to determine the means of contact of the other participants as well as a date/time for the conference. In some embodiments, a participant's name may be associated with the means of contact. In another embodiment, the conference invite message sent from the application server 102 to the individual participants may include a list of all the participants by name, telephone number, other means of contact, or any combination thereof. The conference invite message may be sent to the participating devices using the telephone number as a contact point such as, for instance, in an SMS/text message. Alternatively, the application server may maintain a database of participants and their means of contact (e.g., text/SMS message address, chat/IM address, email address, push notification pop-up, etc.) and send the conference invite to the participant using one or more of the means of contact.

In the illustrated embodiment shown in FIG. 6, the logic flow 600 may cause the participant devices to respond to the conference invite message at block 640. For example, each participating device may receive the conference invite message via one or more means of contact. The user may then respond to the conference invite request via a reply to the way it was received or through a different means of response. A text message response may be returned in response to a text message conference invite. Similarly, an email response may be returned in response to an email conference invite. If the user received the conference invite via a push notification pop-up, the pop-up may include reply options the user may select. Alternatively, for example, an email invite may be responded to via an SMS/text message. Upon selecting a reply option, a response message may be returned to the application server 102 over an IP based connection to which the device is currently connected. In another embodiment, the user may be presented with the telephone number for their device which will be the default means of contact used for the conference. If the user wishes to change the default means of contact in the invitation, he/she may do so in the response message back to the application server 102. Thus, the conference invite message may be structured to allow the user to add or amend a different means of contact for the conference.

In the illustrated embodiment shown in FIG. 6, the logic flow 600 may cause the application server 102 to instruct a conference server 103a to initiate the conference at block 650. For example, the application server 102 may create a data record that may include the names of each participant, the means of contact for each participant, and the date/time of the conference. The data record may be sent to the conference server 103a. At the appropriate time, the conference server 103a may initiate media streams to each of the participants using the means of contact from the data record. As each connection with the participants is made, the conference server 103a may join the media streams together as appropriate to create the appropriate media mix for the conference at block 660.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Although the flowcharts and message diagrams of FIGS. 5-6 each show a specific order of execution, it is understood that the order of execution may differ from that which is depicted. Also, steps shown in succession in the flowcharts may be executed concurrently or with partial concurrence. Further, in some embodiments, one or more of the steps shown in the flowcharts may be skipped or omitted. In addition, any number of counters, state variables, warning semaphores, or messages might be added to the logical flows described herein, for purposes of enhanced utility, accounting, performance measurement, or providing troubleshooting aids, etc. It is understood that all such variations are within the scope of the present disclosure.

Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

A memory is defined herein as including both volatile and nonvolatile memory and data storage components. Volatile components are those that do not retain data values upon loss of power. Nonvolatile components are those that retain data upon a loss of power. Thus, a memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may comprise additional systems designed to coordinate this communication, including, for example, performing load balancing. A processor may be of electrical or of some other available construction.

Although the various modules and other various systems and components described herein may be embodied in software or code executed by general purpose hardware, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Also, any logic, functionality or application described herein, including the bridge module 220, and conferencing modules 215, 315, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A method comprising:
receiving an original conference invite message from an initiating device, the original conference invite message including means of contact data for a conference participant;
creating a customized conference invitation message using the means of contact data of the conference participant;
sending the customized conference invitation message to at least one device associated with the conference participant;
receiving a response message to the customized conference invitation message from at least one device associated with the conference participant, the response message accepting the customized conference invitation message and including a means of contact that can be used to connect with the conference participant;
creating a conference data record including the means of contact associated with the conference participant that accepted the conference invitation and a date/time for the conference; and
forwarding the conference data record to a conference server operable to initiate a conference connection to the conference participant that accepted the conference invitation at the date/time specified using the means of contact included in the response message, wherein the conference connection is joined with other conference participants to create a conference.

2. The method of claim 1, the initiating device comprising one of a mobile phone, a personal computer, a laptop computer, a computer enabled Voice-over Internet Protocol (VoIP) telephony device, and a tablet computer.

3. The method of claim 1, the initiating device comprising one of a mobile phone, a personal computer, a laptop computer, a computer enabled Voice-over Internet Protocol (VoIP) telephony device, and a tablet computer, the initiating device executing a calendar program wherein the original conference invite message is based on detecting a calendar entry on the initiating device.

4. The method of claim 1, the means of contact comprising one or more of, a telephone number, an email address, an instant messaging (IM) address, an Internet address, and a short messaging service (SMS) text messaging address.

5. The method of claim 1, the customized conference invitation message sent via one of short messaging service (SMS) text message, push notification pop-up, email, calendar entry, or instant message.

6. The method of claim 1, the customized conference invitation message including a blank field for an alternate means of contact associated with the conference participant receiving the customized conference invitation message.

7. The method of claim 6, further comprising:
receiving the alternate means of contact in the response to the customized conference invitation message from the conference participant accepting the customized conference invitation message; and
replacing the means of contact with the alternate means of contact such that the conference data record includes the alternate means of contact associated with the conference participant that accepted the conference invitation.

8. The method of claim 1, the conference connection comprising one of a telephone call, a video call, streamed audio, streamed video, a group text chat, or any combination thereof.

9. The method of claim 1, further comprising:
receiving a request message to switch from a current participant device to a different device during an existing conference, the request message including contact means for the different device;
establishing a new media stream with the different device based on the contact means for the different device;
joining the new media stream to the conference; and
terminating the media stream to the current participant device.

10. An apparatus, comprising:
a processor operable to execute one or more software modules, the software modules including instructions that when executed:
receive an original conference invite message from an initiating device, the original conference invite message including means of contact data for a conference participant;
create a customized conference invitation message using the means of contact data of the conference participant;
send the customized conference invitation message to at least one device associated with the conference participant;
receive a response message to the customized conference invitation message from at least one device associated with the conference participant, the response message accepting the customized conference invitation message and including a means of contact that can be used to connect with the conference participant;
create a conference data record including the means of contact associated with the conference participant that accepted the conference invitation and a date/time for the conference; and
forward the conference data record to a conference server operable to initiate a conference connection to the conference participant that accepted the conference invitation at the date/time specified using the means of contact included in the response message, wherein the conference connection is joined with other conference participants.

11. The apparatus of claim 10, the initiating device comprising one of a mobile phone, a personal computer, a laptop computer, a computer enabled Voice-over Internet Protocol (VoIP) telephony device, and a tablet computer.

12. The apparatus of claim 10, the initiating device comprising one of a mobile phone, a personal computer, a laptop computer, a computer enabled Voice-over Internet Protocol (VoIP) telephony device, and a tablet computer, the initiating device executing a calendar program wherein the original conference invite message is based on detecting a calendar entry on the initiating device by the initiating device or one of the software modules of the apparatus.

13. The apparatus of claim 10, the means of contact comprising one or more of, a telephone number, an email address, an instant messaging (IM) address, an Internet address, and a short messaging service (SMS) text messaging address.

14. The apparatus of claim 10, the customized conference invitation message sent via one of short messaging service (SMS) text message, push notification pop-up, email, calendar entry, or instant message.

15. The apparatus of claim 10, the customized conference invitation message including a blank field for an alternate means of contact associated with the conference participant receiving the customized conference invitation message.

16. The apparatus of claim 15, the processor further operable to execute one or more software modules, the software modules including instructions that when executed:
receive the alternate means of contact in the response to the customized conference invitation message from the conference participant accepting the customized conference invitation message; and
replace the means of contact with the alternate means of contact such that the conference data record includes the alternate means of contact associated with the conference participant that accepted the conference invitation.

17. The apparatus of claim 10, the conference connection comprising one of a telephone call, a video call, streamed audio, streamed video, a group text chat, or any combination thereof.

18. The apparatus of claim 10, the processor further operable to execute one or more software modules, the software modules including instructions that when executed:
receive a request message to switch from a current participant device to a different device during an existing conference, the request message including contact means for the different device;
establish a new media stream with the different device based on the contact means for the different device;
join the new media stream to the conference; and
terminate the media stream to the current participant device.

19. At least one machine-readable non-transitory medium comprising a set of instructions executable on a computing device to cause the computing device to:
receive an original conference invite message from an initiating device, the original conference invite message including means of contact data for a conference participant;
create a customized conference invitation message using the means of contact data of the conference participant;
send the customized conference invitation message to at least one device associated with the conference participant;
receive a response message to the customized conference invitation message from at least one device associated with the conference participant, the response message accepting the customized conference invitation message and including a means of contact that can be used to connect with the conference participant;
create a conference data record including the means of contact associated with the conference participant that accepted the conference invitation and a date/time for the conference; and
forward the conference data record to a conference server operable to initiate a conference connection to the conference participant that accepted the conference invitation at the date/time specified using the means of contact included in the response message, wherein the conference connection is joined with other conference participants.

20. The at least one machine-readable non-transitory medium of claim 19, the initiating device comprising one of a mobile phone, a personal computer, a laptop computer, a computer enabled Voice-over Internet Protocol (VoIP) telephony device, and a tablet computer.

21. The at least one machine-readable non-transitory medium of claim 19, the initiating device comprising one of a mobile phone, a personal computer, a laptop computer, a computer enabled Voice-over Internet Protocol (VoIP) telephony device, and a tablet computer, the initiating device executing a calendar program wherein the original conference invite message is based on detecting a calendar entry on the initiating device by the initiating device or the computing device.

22. The at least one machine-readable non-transitory medium of claim 19, the means of contact comprising one or more of, a telephone number, an email address, an instant messaging (IM) address, an Internet address, and a short messaging service (SMS) text messaging address.

23. The at least one machine-readable non-transitory medium of claim 19, the customized conference invitation message sent via one of short messaging service (SMS) text message, push notification pop-up, email, calendar entry, or instant message.

24. The at least one machine-readable non-transitory medium of claim 19, the customized conference invitation message including a blank field for an alternate means of contact associated with the conference participant receiving the customized conference invitation message.

25. The at least one machine-readable non-transitory medium of claim 24, further comprising a set of instructions executable on a computing device to cause the computing device to:
receive the alternate means of contact in the response to the customized conference invitation message from the conference participant accepting the customized conference invitation message; and
replace the means of contact with the alternate means of contact such that the conference data record includes the alternate means of contact associated with the conference participant that accepted the conference invitation.

26. The at least one machine-readable non-transitory medium of claim 19, the conference connection comprising one of a telephone call, a video call, streamed audio, streamed video, a group text chat, or any combination thereof.

27. The at least one machine-readable non-transitory medium of claim 19, further comprising a set of instructions executable on a computing device to cause the computing device to:
receive a request message to switch from a current participant device to a different device during an existing conference, the request message including contact means for the different device;
establish a new media stream with the different device based on the contact means for the different device;
join the new media stream to the conference; and
terminate the media stream to the current participant device.
